(19) United States
(12) Patent Application Publication
(10) Pub. No.: US 2026/0088439 A1
(43) Pub. Date: Mar. 26, 2026

(54) PRESSURE EQUALIZATION DEVICE AND A HOUSING COMPRISING SUCH A PRESSURE EQUALIZATION DEVICE

(71) Applicant: Carl Freudenberg KG, Weinheim (DE)

(72) Inventors: Christian KLEINKE, Darmstadt (DE); Adrian BAUR, Mannheim (DE); Michael SÖNDGEN, Bensheim (DE); Christoph NAUMANN, Viernheim (DE)

(21) Appl. No.: 19/339,669

(22) Filed: Sep. 25, 2025

(30) Foreign Application Priority Data
Sep. 26, 2024 (DE) 10 2024 127 889.7
Feb. 5, 2025 (DE) 10 2025 104 226.8

(51) Int. Cl. H01M 50/325; H01M 50/30

(52) U.S. Cl. CPC H01M 50/325; H01M 50/394

(57) ABSTRACT

A pressure equalization device includes a retaining part having a gas passage opening and a membrane made of a flexible rubber material, where the membrane is retained on the retaining part and covers the gas passage opening. An ambient pressure is applied on one side of the membrane and pressure to be equalized is applied on the other side of the membrane, where the membrane has a metastable first state and a stable second state depending on differential pressure. The membrane, starting from a retained position in which it sealingly covers the gas passage opening, is metastable, and is sealingly retained on the retaining part, snaps into an open position in which it is stable, is released from the retaining part, and opens the gas passage opening.

### CROSS REFERENCE TO RELATED APPLICATIONS

This application claims benefit to German Patent Applications No. DE 10 2025 104 226.8, filed on Feb. 5, 2025, and DE 10 2024 127 889.7, filed on Sep. 26, 2024, which are hereby incorporated by reference herein.

### FIELD

The invention relates to a pressure equalization device and a housing comprising such a pressure equalization device.

### BACKGROUND

Previous pressure equalization devices include DE 10 2017 003 360 B3 which discloses a pressure equalization device for a housing. The known pressure equalization device has an inside, an outside, and a cage, comprising a gas passage opening, the gas passage opening connecting the inside and the outside in a flow-conducting manner depending on the differential pressure. The gas passage opening is covered by a gas-permeable membrane, which is assigned a pressure-relief valve, which is formed as an anti-rupture means, in a functionally parallel connection.

EP 2 545 882 A1 discloses a further pressure equalization device. The pressure equalization device is intended for equalizing an internal pressure in a housing, there being an electrochemical device arranged inside the housing. A gas-permeable membrane can be deformed according to changes in the internal pressure and preferably consists of a polytetrafluoroethylene (PTFE) material. Normally, the membrane allows pressure to be equalized between the inside and the outside. If the internal pressure in the housing becomes undesirably high, the membrane is destroyed by a spike formed as an emergency gas-release element. The destroyed membrane opens a gas passage opening for an emergency release of gas from the housing. This creates an anti-rupture means for the housing.

### SUMMARY

In an embodiment, the present disclosure provides a pressure equalization device that includes a retaining part having a gas passage opening and a membrane made of a flexible rubber material, where the membrane is retained on the retaining part and covers the gas passage opening. An ambient pressure is applied on one side of the membrane and pressure to be equalized is applied on the other side of the membrane, where the membrane has a metastable first state and a stable second state depending on differential pressure. The membrane, starting from a retained position in which it sealingly covers the gas passage opening, is metastable, and is sealingly retained on the retaining part, snaps into an open position in which it is stable, is released from the retaining part, and opens the gas passage opening.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a first embodiment of the pressure equalization device during its proper use in an operating state in which there is no differential pressure or only a very small differential pressure applied at the membrane;

FIG. 2 shows an operating state of the pressure equalization device from FIG. 1 in which a pressure to be equalized is building inside a housing and the membrane is moving out of its metastable first state into the stable second state depending on the differential pressure;

FIG. 3 shows the pressure equalization device from FIGS. 1 and 2, the gas passage opening being fully opened and the pressure having been fully equalized. The membrane is in its open position and is fully released from the retaining part;

FIG. 4 shows a second embodiment of the pressure equalization device similar to the embodiment from FIG. 1, the membrane having a gas-permeable central region;

FIG. 5 shows a third embodiment of the pressure equalization device similar to the embodiment from FIG. 1, the membrane being covered by an interceptor lid;

FIG. 6 shows the third embodiment from FIG. 5 in an operating state of the pressure equalization device in which a pressure to be equalized is building inside a housing and the membrane is moving out of its metastable first state into the stable second state depending on the differential pressure;

FIG. 7 shows the third embodiment from FIGS. 5 and 6, the gas passage opening being fully opened and the pressure having been fully equalized. The membrane is in its open position, is fully released from the retaining part, and has been intercepted inside the interceptor lid;

FIG. 8 shows a fourth embodiment of the pressure equalization device similar to the third embodiment from FIG. 5, the membrane having a gas-permeable central region as in the second embodiment from FIG. 4;

FIG. 9 shows the fourth embodiment from FIG. 8 in an operating state of the pressure equalization device in which a pressure to be equalized is building inside a housing and the membrane is moving out of its metastable first state into the stable second state depending on the differential pressure;

FIG. 10 shows the pressure equalization device from FIGS. 8 and 9, the gas passage opening being fully opened and the pressure having been fully equalized. The membrane is in its open position, is fully released from the retaining part, and has been intercepted inside the interceptor lid; and

FIG. 11 shows a housing comprising one of the pressure equalization devices from FIGS. 1 to 10.

### DETAILED DESCRIPTION

Embodiments of the present disclosure include a pressure equalization device that has a simple construction that requires few parts, meaning that it is simple and cost-effective to produce in manufacturing and economic terms, and operates reliably over a long service life. Moreover, the pressure equalization device should allow for very quick pressure equalization by allowing extremely high volume flow rates to quickly flow therethrough.

An embodiment of the present disclosure includes a pressure equalization device comprising a retaining part having a gas passage opening and a membrane made of a flexible rubber material, wherein the membrane is retained on the retaining part and covers the gas passage opening, wherein ambient pressure is applied on one side of the membrane and pressure to be equalized is applied on the other side, wherein the membrane has a metastable first state and a stable second state depending on the differential pressure, and wherein the membrane, starting from a retained position in which it sealingly covers the gas passage opening, is metastable, and is sealingly retained on the retaining part, can snap into an open position in which it is stable, is released from the retaining part, and opens the gas passage opening.

The pressure to be equalized is the pressure prevailing, for example, in a housing on which the pressure equalization device is used.

The ambient pressure may be atmospheric pressure.

The pressure equalization device may be intended for a housing and be assembled in a housing wall of the housing and/or integrated in a lid for the housing. The advantage of the pressure equalization device is that the pressure is equalized very quickly by high volume flow rates, using solely the snap-mounted membrane. As a result, the pressure equalization device has a particularly simple construction that requires few parts, meaning that it is simple and cost-effective to produce in manufacturing terms.

In an embodiment of the present disclosure, the pressure equalization device guarantees only slight fluctuations in the trigger pressure.

The pressure is equalized non-destructively.

This also means that the pressure equalization device can undergo a full functional test.

A full functional test of this kind is possible because no material is destroyed in the pressure equalization device during its proper use. In an embodiment of the present disclosure, no burst films, which are often subject to significant aging effects, are used.

During production, the pressure equalization device can undergo a functional test in which the membrane is loaded up to the point at which it snaps into the open position. The differential pressure when the membrane switches from the metastable first state into the stable second state can be measured in the process. If said pressure is within the specified tolerance range, then because the state change is non-destructive, the membrane can be installed in the pressure equalization device again and placed in the metastable first state before the component is packaged and shipped ready for use.

The membrane can be actuated depending on the differential pressure and has a metastable first state and a stable second state.

The metastability is a weak form of the stability. The metastable first state is stable in the face of relatively small changes in the differential pressure at the membrane but unstable in the face of larger changes.

It is only when the higher differential pressures ascertained during the design of the pressure equalization device are applied to the membrane that it snaps from its metastable first state into its stable second state.

So-called twist-off lids also have a metastable and a stable state. Owing to a vacuum in the container sealed by the twist-off lid, the middle part of the twist-off lid, which is configured in the form of a pop-up button, is held in a metastable state. When air flows into the previously sealed container as the twist-off lid is opened, the middle part of the lid snaps into its stable state as manufactured.

The flexible rubber material of which the membrane consists is impermeable to gas. This is advantageous in that differential pressures are applied at the membrane practically instantaneously and immediately bring about the actuation of said membrane. The pressure to be equalized cannot escape through the flexible rubber, gas-impermeable membrane.

According to an embodiment of the present disclosure, it can be provided that, in the metastable first state, the membrane has a first shape that bulges toward the pressure to be equalized. The membrane is thus kept below a differential pressure threshold when in its first shape.

The first shape may be substantially lenticular.

By contrast, in the stable second state, the membrane preferably has a second shape that bulges in the opposite direction to the pressure to be equalized.

The second shape may be substantially hemispherical.

When the pressure increases in the interior of a housing, for example a battery housing, and the increase is in a non-critical range, the membrane is kept in its metastable first state in the retained position, in which it sealingly covers the gas passage opening. Here, the membrane is sealingly retained on the retaining part.

When the pressure increases further in the interior of the housing, a critical threshold is then reached at which the membrane snaps from its metastable first state into the stable second state and thus into the open position. In the open position, the membrane is released from the retaining part and opens the gas passage opening.

The membrane snaps from the metastable first state into the stable second state practically instantly, such that the largest possible passage cross section through the gas passage opening is opened in a very short time. As a result, the differential pressure is equalized as quickly as possible, thus minimizing a risk of damage to the housing on which the pressure equalization device is used.

The configuration of the pressure equalization element also provides the advantage whereby relatively large production tolerances during production of the pressure equalization device have little impact on the performance characteristics of the pressure equalization device.

Allowing larger production tolerances means production costs are reduced.

Owing to the snap-mounted membrane, there are no further tolerance links to other components of the pressure equalization device, for example the retaining part.

That is because the membrane, when it snaps out of the metastable state into the stable state, undergoes a considerably larger displacement by comparison with the production tolerances of the membrane. Often, this displacement is a multiple of the production tolerances. This ensures good functional reliability of the pressure equalization device, in particular of the membrane during snapping.

To guarantee defined performance characteristics, in particular defined snapping of the membrane out of the metastable first state into the stable second state, the membrane can, on the side facing the pressure to be sealed, be assigned a gas-permeable supporting member with which the membrane is in abutting contact when in its metastable first state. The supporting action of the supporting member is advantageous for preventing the membrane, which is made of flexible rubber material, from undergoing undesirably large deformations in its metastable first state which would reduce its service life. Thus, the pressure equalization device has consistently good performance characteristics over a long service life.

Moreover, a supporting member is advantageous in particular when the flexible rubber material of the membrane is pliable.

The supporting member may be formed as a supporting grate. Thus, the flexible rubber membrane is supported but is not prevented from being loaded with pressure to be equalized.

As regards the ability to produce the pressure equalization device simply and cost-effectively, it can be provided that the supporting member is formed in one piece with and of the same material as the retaining part. Thus, the pressure equalization device overall has a structure that requires few parts.

The membrane may enclose a gas-permeable central region. The membrane forms a pressure-relief valve formed as an anti-rupture means, the membrane and the gas-permeable central region being arranged in a functionally parallel connection. By way of example, the gas-permeable central region may consist of expanded polytetrafluoroethylene (e-PTFE) or of a nonwoven fabric composite part comprising at least one layer of nonwoven fabric. The gas-permeable central region forms a breathable membrane part. In this case, the gas-permeable central region covers a central opening in the membrane, which is made of flexible rubber material, and thereby seals it.

In an embodiment of the present disclosure, the flexible rubber material is not gas-permeable.

In a case such as this, the pressure equalization device additionally has air inlet and air discharge during normal operation, as is the case in the pressure equalization device from DE 10 2017 003 360 B3 described at the outset.

According to an embodiment of the present disclosure, it can be provided that the central region has an annular retaining element, which is arranged coaxially and sealingly in the membrane and has a cut-out, wherein the cut-out is covered by a gas-permeable central membrane. The central membrane is connected to the flexible rubber material by means of the retaining element. The retaining element and the central membrane may form a unit that can be pre-assembled. This simplifies the assembly of the pressure equalization device.

The retaining element may preferably consist of a hard tough material. A polymer material may preferably be used as the material.

The retaining element is sealingly enclosed by the flexible rubber material of the membrane and is connected to the flexible rubber material of the membrane in an interlocking and/or integrally bonded manner. Owing to the gas-tight connection between the retaining element and the flexible rubber material of the membrane, a short circuit in the flow in this region, which would be detrimental to the performance characteristics, is prevented during the proper use of the pressure equalization device. Changes in the differential pressure at the membrane thus bring about an immediate reaction by the membrane.

The central membrane may consist of e-PTFE or a nonwoven fabric composite material comprising at least one layer of nonwoven fabric. A nonwoven fabric composite material has good gas-permeability, but also the central membrane protects the interior of a housing on which the pressure equalization device is used from becoming loaded with moisture and/or contaminants.

On its side facing away from the pressure to be equalized, the central membrane may be covered by a grate-like protective lid. The central membrane, which is more sensitive by comparison with the flexible rubber material of the membrane, is thus protected against external influences that would reduce its service life.

Preferably, the protective lid is fastened to the retaining element. These two components are positioned spatially close to one another such that securing them to one another is structurally advantageous.

The membrane may be covered by a dome-like and grate-like interceptor lid for the membrane in its open position. The advantage here is that when the membrane is projected away from the retaining part to equalize undesirably high differential pressures at the membrane, it does not reach the surroundings in an uncontrolled manner but rather is kept inside the pressure equalization device by the interceptor lid.

The interceptor lid may have air inlet and air discharge openings. Thus, the excess pressure to be equalized reaches the surroundings in an unconstrained manner.

The interceptor lid is preferably secured to the retaining part or to the supporting member. Securing of this kind is structurally simple, just like the assembly of the pressure equalization device, in particular the assembly of the interceptor lid on the retaining part.

The interceptor lid and the retaining part or the supporting member may be interconnected so as to be displaceable relatively in the axial direction. The advantage here is that a larger useful area of the air inlet and air discharge openings of the interceptor lid is opened for dissipating the pressure to be equalized.

The membrane may be fully released from the retaining part in its open position.

To quickly equalize the pressure through high volume flow rates, the membrane is projected away from the retaining part.

An embodiment of the present disclosure includes a housing comprising a pressure equalization device as described herein and at least one delimiting wall, which delimits the inner chamber of the housing and separates it from the surroundings of the housing, wherein at least one gas-permeable housing membrane is arranged in the delimiting wall, and wherein the membrane is arranged in a functionally parallel connection with the central membrane and/or the housing membrane.

During the proper use of the housing, pressure is equalized through the central membrane and/or the housing membrane, which are each gas-permeable. If a differential pressure above an as yet permissible threshold is reached at the membrane, the membrane, which is made of elastomeric material, opens as described above.

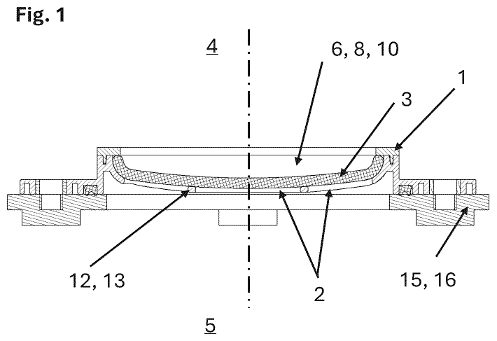

FIGS. 1 to 3 show a first embodiment of a pressure equalization device according to the present disclosure.

The pressure equalization device is part of an arrangement that comprises a housing 15, in this case a battery housing 16, in addition to the pressure equalization device. The pressure equalization device and the housing 15 can be interconnected by conventional connections. For example, the connection can be established by a screw connection or a bayonet connection.

The pressure equalization device comprises the retaining part 1, which consists of a hard tough material, for example a polymer material. The retaining part 1 has the centrally arranged gas passage opening 2 covered by the membrane 3, which is made of flexible rubber material.

In FIG. 1, the arrangement is shown during its proper use, there being no differential pressure applied to the membrane 3, as shown here.

The membrane 3 is sealingly retained on the retaining part 1, ambient pressure 4 being applied on the outside of the membrane 3 and the pressure 5 to be equalized being applied on the inside. The state which the membrane 3 is in when in the operating state shown is the metastable first state 6.

In the metastable first state 6 shown, the membrane 3 has a first shape 10 that bulges toward the pressure 5 to be equalized, i.e., the membrane bulges in a substantially lenticular manner toward the pressure 5 to be equalized.

On the side facing the pressure 5 to be equalized, the membrane is supported on the supporting member 12, which is formed to be gas-permeable and as a supporting grate 13.

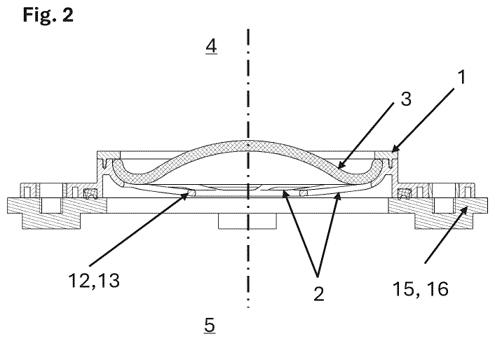

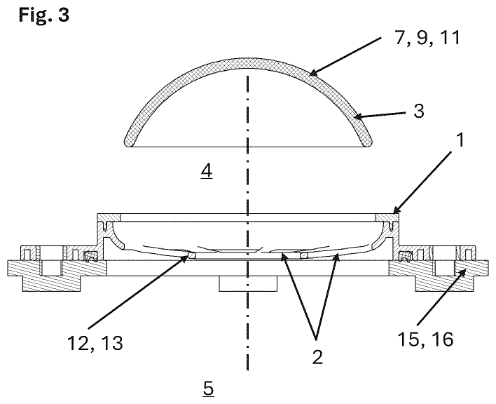

In FIG. 2, by comparison with the operating state shown in FIG. 1, the pressure 5 to be equalized is higher and is building. Owing to the increasing differential pressure at the membrane, the membrane is moving from the metastable first state 6 shown in FIG. 1 into the stable second state 7 shown in FIG. 3.

In FIG. 2, the membrane 3 is still sealingly connected to the retaining part 1 but is already elastically deformed toward the stable second state 7. In the shown position of the membrane 3, the membrane snaps from the retained position 8 into the open position 9 shown in FIG. 3.

In FIG. 3, the membrane 3 is shown in its open position 9 and is in its stable second state 7. It is entirely released from the retaining part 1 and fully opens the gas passage opening 2.

The membrane 3 is in the stable second state 7, which corresponds to the state of the membrane 3 as manufactured. The second shape 11 is substantially hemispherical.

Depending on the conditions in each use case, the membrane 3 may have a gas-permeable central region 14 enclosed by the flexible rubber material, which is not gas-permeable.

The supporting member 12, which the membrane 3 abuts with resilient preloading in the operating state shown in FIG. 1, is formed in one piece with and of the same material as the retaining part 1.

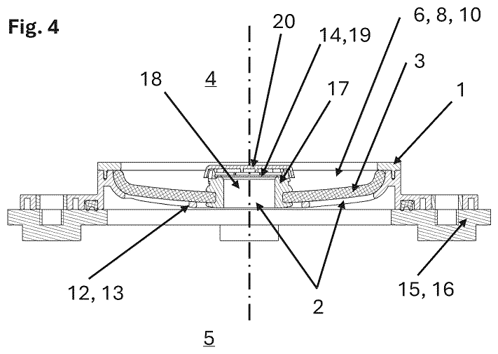

FIG. 4 shows a second embodiment of the pressure equalization device similar to the first embodiment example from FIG. 1, the membrane 3 having a gas-permeable central region 14.

The arrangement is shown during its proper use, there being no differential pressure applied to the membrane 3, as shown here.

The membrane 3 is sealingly retained on the retaining part 1, ambient pressure 4 being applied on the outside of the membrane 3 and the pressure 5 to be equalized being applied on the inside. The state which the membrane 3 is in when in the operating state shown is the metastable first state 6.

In the metastable first state 6 shown, the membrane 3 has a first shape 10 that bulges toward the pressure 5 to be equalized, i.e., the membrane bulges in a substantially lenticular manner toward the pressure 5 to be equalized.

On the side facing the pressure 5 to be equalized, the membrane is supported on the supporting member 12, which is formed to be gas-permeable and as a supporting grate 13.

The central region 14 comprises an annular retaining element 17 which is arranged coaxially and sealingly in the membrane 3 and has a cut-out 18, the cut-out 18 being covered by the gas-permeable central membrane 19. The gas-permeable central membrane 19 creates a flow-conducting connection between the inside of the housing 15, having the pressure 5 to be equalized, and the surroundings of the pressure equalization device, with ambient pressure 4 prevailing in the surroundings. The central membrane 19 is connected to the flexible rubber material by means of the retaining element 17. The retaining element 17 and the central membrane 19 form a pre-assembled unit.

The retaining element 17 consists of a hard tough polymer material.

The retaining element 17 is sealingly enclosed by the flexible rubber material of the membrane 13 and is connected to the flexible rubber material of the membrane 3 in an interlocking and/or integrally bonded manner. The gas-tight connection prevents a short circuit in the flow during the proper use of the pressure equalization device, which would be detrimental to the performance characteristics. Changes in the differential pressure at the membrane 3 thus bring about an immediate reaction by the membrane.

In this exemplary embodiment, the central membrane 19 consists of a nonwoven fabric composite material comprising at least one layer of nonwoven fabric. A nonwoven fabric composite material has good gas-permeability, but also the central membrane protects the interior of the housing 15 on which the pressure equalization device is used from becoming loaded with moisture and/or contaminants.

On its side facing away from the pressure 5 to be equalized, the central membrane 19 is covered by the grate-like protective lid 20. The protective lid 20 also consists of a polymer material. The central membrane 19, which is more sensitive by comparison with the flexible rubber material of the membrane 3, is thus protected against external influences that would reduce its service life.

The protective lid 20 is fastened to the retaining element 17.

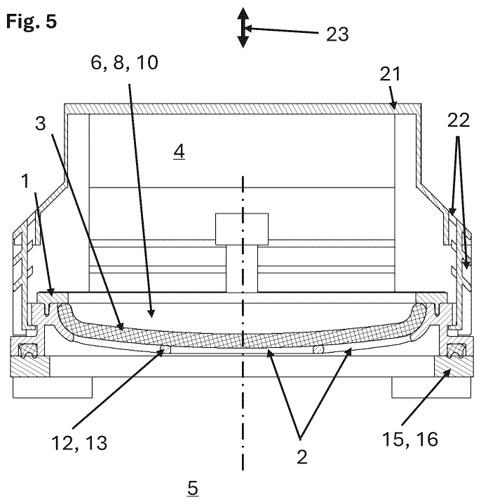

FIG. 5 shows a third embodiment of the pressure equalization device similar to the embodiment from FIG. 1, the membrane 3 being covered by the interceptor lid 21.

The interceptor lid 21 is formed in a dome-like and grate-like manner and catches the membrane 3 when it is fully lifted off the retaining part 1 in the open position 9. The advantage here is that when the membrane 3 is projected away from the retaining part 1 to equalize undesirably high differential pressures at the membrane 3, it does not reach the surroundings in an uncontrolled manner but rather is kept inside the pressure equalization device by the interceptor lid 21.

The interceptor lid 21 has air inlet and air discharge openings 22. Thus, the excess pressure 5 to be equalized can reach the surroundings 4 in an unconstrained manner.

The interceptor lid 21 is secured to the retaining part 1 so as to be displaceable in the axial direction 23. Securing of this kind is structurally advantageous, just like the assembly of the pressure equalization device, in particular the assembly of the interceptor lid 21 on the retaining part 1.

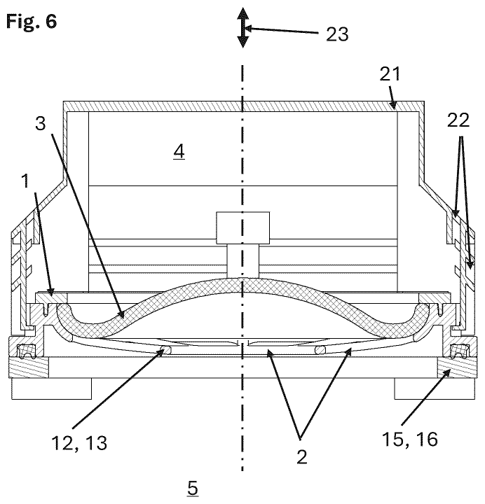

FIG. 6 shows the third embodiment from FIG. 5 in an operating state in which a pressure 5 to be equalized is building inside the housing 15 and the membrane 3 is moving out of its metastable first state 6 into the stable second state 7 depending on the differential pressure.

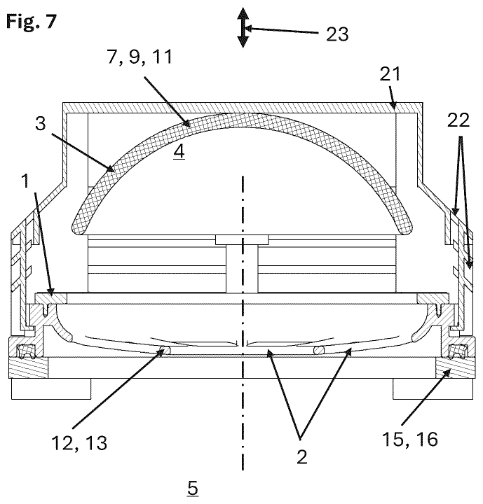

FIG. 7 shows the third embodiment from FIGS. 5 and 6, the gas passage opening 2 being fully opened and the pressure having been fully equalized. The membrane 3 is in its open position 9 and is fully released from the retaining part 1.

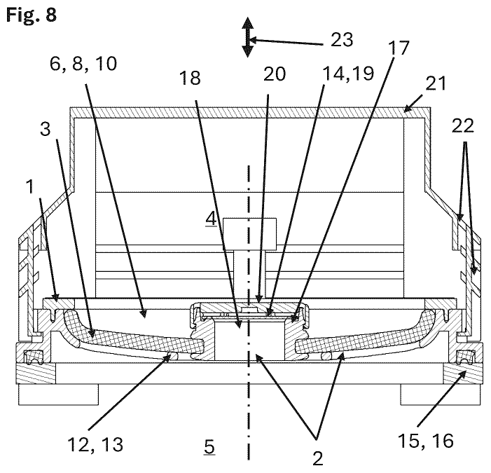

FIG. 8 shows a fourth embodiment of the pressure equalization device similar to the embodiment from FIG. 5, the membrane 3 having the gas-permeable central region 14 that has the central membrane 19.

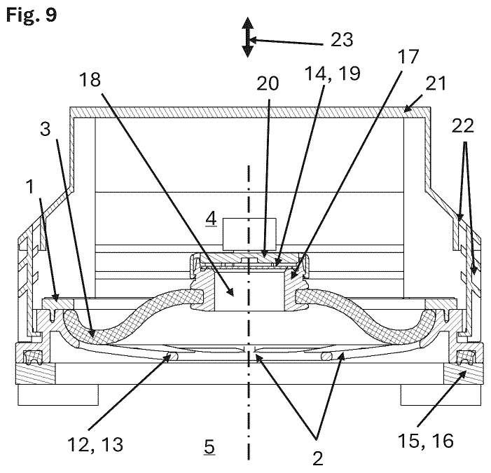

FIG. 9 shows the fourth embodiment from FIG. 8 in an operating state of the pressure equalization device in which a pressure 5 to be equalized is building inside the housing 15 and the membrane 3 is moving out of its metastable first state 6 into the stable second state 7 depending on the differential pressure.

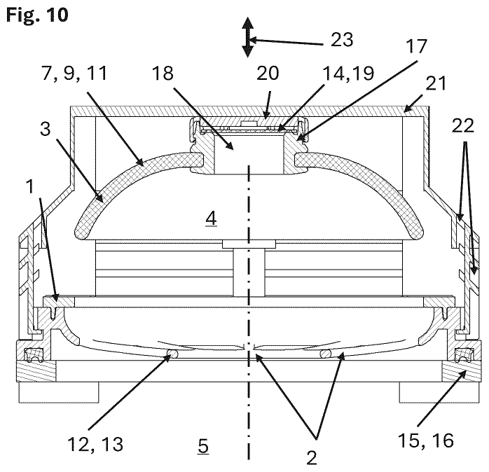

FIG. 10 shows the pressure equalization device from FIGS. 8 and 9, the gas passage opening 2 being fully opened and the pressure having been fully equalized. The membrane 3 is in its open position 9 and is fully released from the retaining part 1.

The pressure equalization device—and also the entire arrangement comprising the pressure equalization device—has a simple construction that requires few parts, meaning that it is cost-effective to produce in economic terms. The pressure equalization device has consistently good performance characteristics over a long service life.

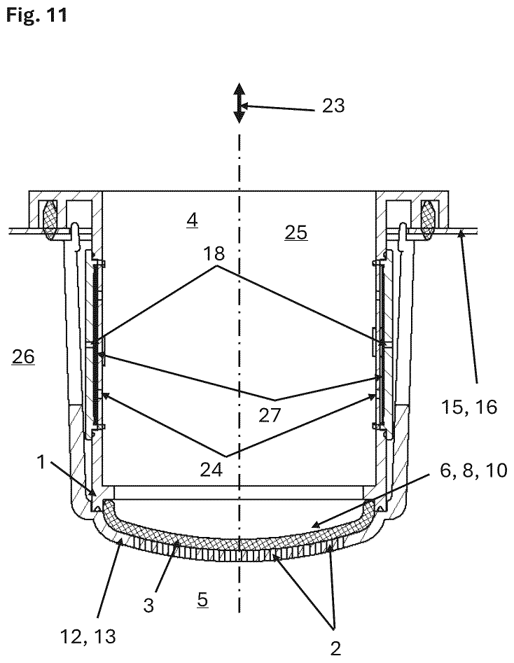

FIG. 11 shows a housing 15, 16 comprising a pressure equalization device as described above. The housing 15, 16 comprises a delimiting wall 24, which delimits the inner chamber 25 of the housing 15, 16 and separates it from the surroundings 26 of the housing 15, 16. At least one gas-permeable housing membrane 27 is arranged in the delimiting wall. In the embodiment example shown, the membrane 3 is arranged in a functionally parallel connection with the housing membrane 27.

During the proper use of the housing 15, 16, pressure is equalized through the housing membrane 27, which is gas-permeable. However, if a differential pressure above an as yet permissible threshold is reached at the gas-impermeable elastomer membrane 3, the membrane 3 opens in the manner of a pressure-relief valve, as described above, to prevent damage to or destruction of the housing 15, 16.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A pressure equalization device comprising a retaining part having a gas passage opening and a membrane made of a flexible rubber material,
wherein the membrane is retained on the retaining part and covers the gas passage opening,
wherein ambient pressure is applied on one side of the membrane and pressure to be equalized is applied on the other side of the membrane,
wherein the membrane has a metastable first state and a stable second state depending on differential pressure, and
wherein the membrane, starting from a retained position in which it sealingly covers the gas passage opening, is metastable, and is sealingly retained on the retaining part, snaps into an open position in which it is stable, is released from the retaining part, and opens the gas passage opening.

2. The pressure equalization device according to claim 1, wherein the membrane is impermeable to gas.

3. The pressure equalization device according to claim 1, wherein in the metastable first state, the membrane has a first shape that bulges toward the pressure to be equalized.

4. The pressure equalization device according to claim 3, wherein the first shape is lenticular.

5. The pressure equalization device according to claim 3, wherein in the stable second state, the membrane has a second shape that bulges in an opposite direction to the pressure to be equalized.

6. The pressure equalization device according to claim 5, wherein the second shape is hemispherical.

7. The pressure equalization device according to claim 1, wherein on the side facing the pressure to be equalized, the membrane is assigned a gas-permeable supporting member with which the membrane is in abutting contact when in the metastable first state.

8. The pressure equalization device according to claim 7, wherein the gas-permeable supporting member is formed as a supporting grate.

9. The pressure equalization device according to claim 7, wherein the supporting member is formed in one piece with and of a same material as the retaining part.

10. The pressure equalization device according to claim 1, wherein the membrane encloses a gas-permeable central region.

11. The pressure equalization device according to claim 10, wherein the gas-permeable central region has an annular retaining element, which is arranged coaxially and sealingly in the membrane and has a cut-out, and wherein the cut-out is covered by a gas-permeable central membrane.

12. The pressure equalization device according to claim 11, wherein the annular retaining element comprises a polymer material.

13. The pressure equalization device according to claim 11, wherein the annular retaining element is sealingly enclosed by the flexible rubber material of the membrane and is connected to the flexible rubber material of the membrane in an interlocking and/or integrally bonded manner.

14. The pressure equalization device according to claim 11, wherein the gas-permeable central membrane is comprised of expanded polytetrafluoroethylene (e-PTFE) or a nonwoven fabric composite material comprising at least one layer of nonwoven fabric.

15. The pressure equalization device according to claim 11, wherein on the side facing away from the pressure to be equalized, the gas-permeable central membrane is covered by a grate-like protective lid.

16. The pressure equalization device according to claim 15, wherein the grate-like protective lid is secured to the annular retaining element.

17. The pressure equalization device according to claim 7, wherein the membrane is covered by a dome-like and grate-like interceptor lid for the membrane in the open position.

18. The pressure equalization device according to claim 17, wherein the dome-like and grate-like interceptor lid has air inlet and air discharge openings.

19. The pressure equalization device according to claim 17, characterized in that the dome-like and grate-like interceptor lid is secured to the retaining part or to the supporting member.

20. The pressure equalization device according to claim 17, wherein the dome-like and grate-like interceptor lid and the retaining part or the supporting member are interconnected so as to be displaceable relatively in an axial direction.

21. The pressure equalization device according to claim 1, wherein the membrane is fully released from the retaining part when in the open position.

22. A housing comprising:
a pressure equalization device according to claim 1; and
at least one delimiting wall that delimits an inner chamber of the housing and separates the housing from surroundings of the housing, wherein at least one gas-permeable housing membrane is arranged in the delimiting wall, and wherein the membrane is arranged in a functionally parallel connection with a gas-permeable central membrane and/or the gas-permeable housing membrane.
